(19) United States
(12) Patent Application Publication
(10) Pub. No.: US 2012/0242623 A1
(43) Pub. Date: Sep. 27, 2012

(54) TOUCH SENSITIVE DEVICE AND DISPLAY DEVICE EMPLOYING THE SAME

(75) Inventors: HSIEN-LUNG HO, Tu-Cheng (TW); CHIU-HSIUNG LIN, Tu-Cheng (TW); KUAN-JUI HUANG, Tu-Cheng (TW)

(73) Assignee: HON HAI PRECISION INDUSTRY CO., LTD., Tu-Cheng (TW)

(21) Appl. No.: 13/300,642

(22) Filed: Nov. 20, 2011

(30) Foreign Application Priority Data
Mar. 24, 2011 (TW) 100110004

(51) Int. Cl. G06F 3/042

(52) U.S. Cl. 345/175

(57) ABSTRACT

A display device includes a display layer and a light guide plate (LGP) arranged on the display layer. A transparent plate is arranged between the LGP and the display layer, and the transparent plate houses a array of IR sensors. An IR source is arranged on the lateral surface of the LGP, and a scanning mirror is arranged on the lateral surface of the LGP. The IR sensors sense the IR light beams and determine whether a strength of the sensed IR light beams is decreased to below a predetermined threshold value, caused by a touch by a user, on the transparent plate at a location of said IR sensor, and send a signal associated with the touch to the control unit, the control unit is configured to receive the signal and determine the touch point according to the location of said IR sensor.

### BACKGROUND

1. Technical Field

The present disclosure relates to a touch sensitive device, especially to an infrared (IR) touch sensitive device and a display device employing the infrared touch sensitive device.

2. Description of Related Art

A typical IR touch sensitive device, includes a number of IR emitters and a number of IR receivers distributed on the edges of a screen of the IR touch sensitive device. Infrared rays emitted by the IR emitters transmit onto the surface of the screen. With such structure, a space must be reserved in the IR touch sensitive device for transmitting the infrared rays. Therefore, the structure of the IR touch sensitive device is not amenable to miniaturization.

Therefore, what is needed is an IR touch sensitive device alleviating the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of a reflective display device with an Touch sensitive unit in accordance with a first exemplary embodiment.

FIG. 2 is a schematic, isometric view showing the Touch sensitive unit of the reflective display device of FIG. 1.

FIG. 3 is an isometric view showing the light guide plate (LGP) of the reflective display device of FIG. 1.

FIG. 4 is a cross-sectional view of the light paths of the Touch sensitive unit of the reflective display device of FIG. 1.

FIG. 5 is an isometric view showing the transparent plate of the reflective display device of FIG. 1.

FIG. 6 is a block diagram of the reflective display device with a Touch sensitive unit in accordance with the first exemplary embodiment.

FIG. 7 is an isometric view showing the Touch sensitive unit of a display device in accordance with a second exemplary embodiment.

FIG. 8 is an isometric view showing the Touch sensitive unit of a display device in accordance with a third exemplary embodiment.

FIG. 9 is an isometric view showing a reflective display device in accordance with in accordance with a fourth exemplary embodiment.

FIG. 10 is an isometric view showing the Touch sensitive unit of the reflective display device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

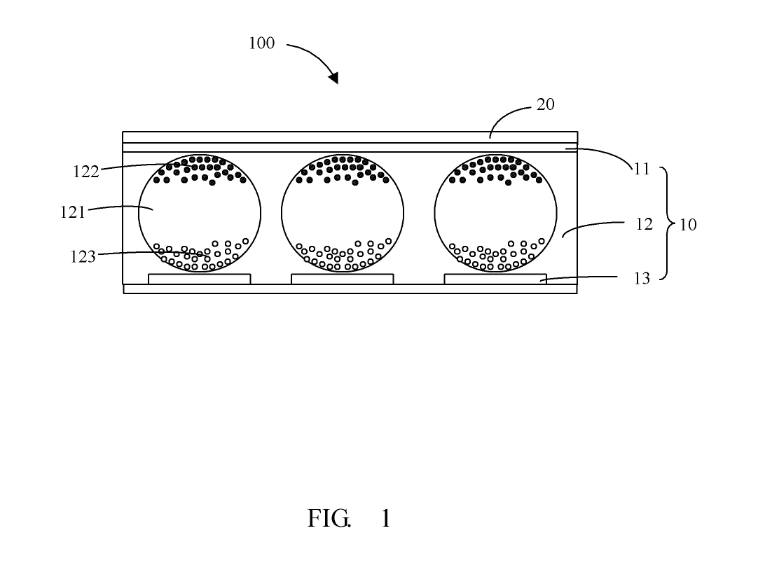

Referring to FIG. 1, a first embodiment of a reflective display device 100 with an IR touch input function is illustrated. The reflective display device 100 includes a display layer 10, a light guide plate (LGP) 20, a substrate 30, and a power unit (not shown). The display layer 10 is arranged between the LGP 20 and the substrate 30. In a first embodiment, the display layer 10 includes a common electrode 11, an electrophoretic medium layer 12, and a pixel electrode 13.

The common electrode 11 is located between the LGP 20 and the electrophoretic medium layer 12, which corresponds to the display area of the LGP 20. The common electrode 11 can be made of indium tin oxide (ITO). The pixel electrode 13 is located between the substrate 30 and the electrophoretic medium layer 12. The pixel electrode 13 includes a number of thin film transistor (TFT) electrodes.

The electrophoretic medium layer 12 is a bistable electrophoretic display medium, and in the first embodiment, the electrophoretic medium layer 12 can be an encapsulated electrophoretic medium. The electrophoretic medium layer 12 includes a number of microcapsules 121, each of which comprises a capsule wall containing suspension fluid in which a number of first charged particles 122 and a number of second charged particles 123 are suspended. The first charged particles 122 and the second charged particles 123 are provided with different optical and electrical properties. Upon the application of an electrical field between the common electrode 11 and the pixel electrode 13, either the first charged particles 122 or the second charged particles 123 move to the common electrode 11 and the very small-scale presence or absence of the particles 122 and 123 at the electrode 11 layer forms images on the display device 100.

The LGP 20 is transparent and may be made of plastic or glass, such as polymethyl methacrylate (PMMA).

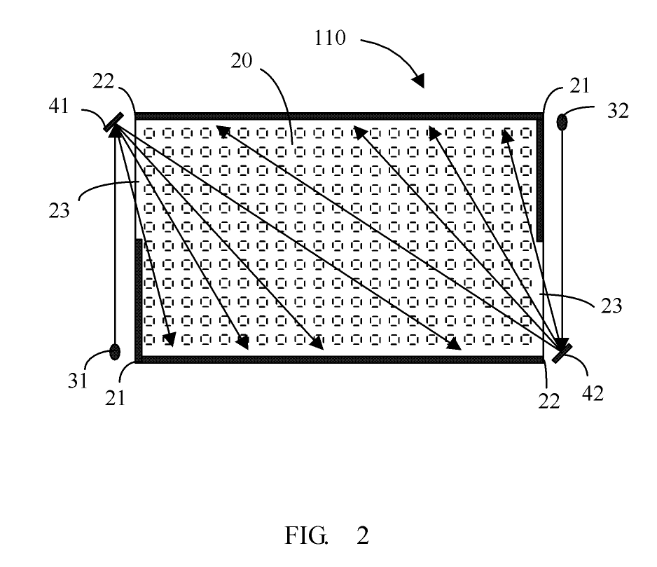

Referring to FIG. 2, a touch sensitive unit 110 is illustrated. In a first embodiment, the LGP 20 is rectangular. The touch input unit 110 includes two IR light sources 31, 32 which are arranged on first diagonally-opposite corners of the LGP 20. Two scanning mirrors 41, 42 are arranged on the other two corners of the LGP 20. The scanning mirrors 41, 42 are biaxial Micro-Electro-Mechanical System (MEMS) scanning mirrors that have three-dimensional scanning ability, and can reflect light beams.

The IR beams emitted from the IR source 31 travel to the scanning mirror 41, and are reflected by the scanning mirror 41. The reflected IR beams travel in different directions (in three dimensions) because of the tilting of the reflection plane of the scanning mirror 41. The reflected IR beams then enter the LGP 20 through the incidence portion 23 defined on the lateral surface of the LGP 20. In a similar way, the IR beams emitted from the IR source 32 are reflected by the scanning mirror 42, and the reflected IR beams enter the LGP 20 through the incidence portion 23.

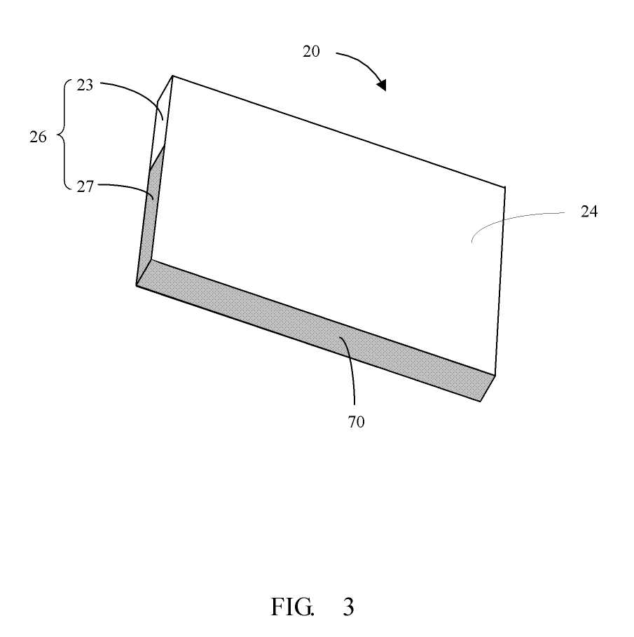

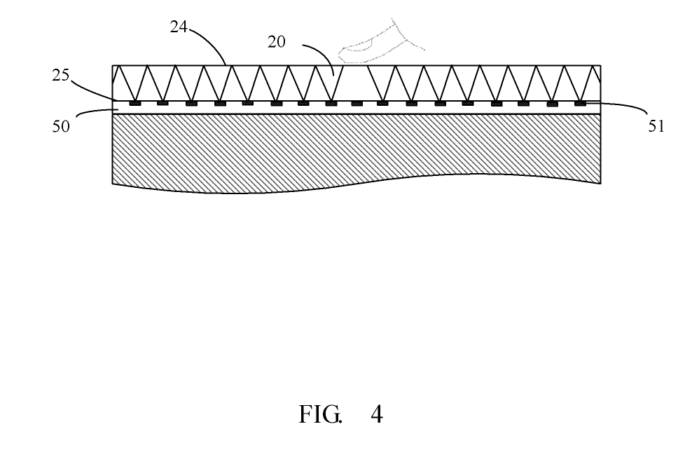

Referring to FIGS. 3 and 4, the LGP 20 includes a first surface 24, an opposite, second surface 25 and a lateral surface 26 between the first and second surfaces. The lateral surface 26 of the LGP 20 includes the light incident portion 23 and a light reflection portion 27, a reflection film 70 is applied on the light reflecting portion 27 of the lateral surface 26. The light beams reaching the reflection film 70 will be reflected back, and not scattered or lost. The reflection film 70 can be a metal reflective coating chosen from the group consisting of an aluminum coating, a gold coating and a silver coating, arranged on the sidewall of the LGP 20.

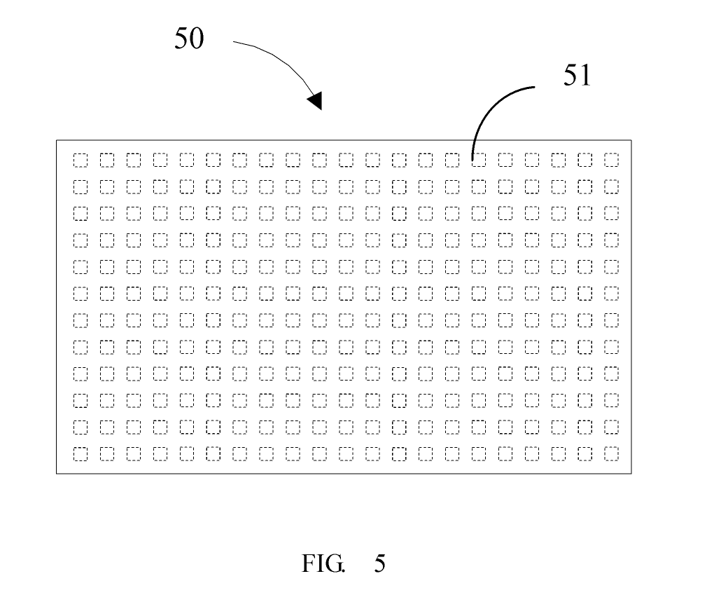

Referring to FIGS. 4 and 5, the touch sensitive unit 110 further includes a transparent plate 50 arranged between the second surface 25 and the display layer 10. The transparent plate 50 includes a plurality of IR sensors 51. In this embodiment, the IR sensors 51 are disposed on the surface of the transparent plate 50. The IR sensors 51 can be formed by film-printing process or semi-conductor processing technology, including the steps of printing a number of circuit layers and a number of IR sensitive layers on the surface of the transparent plate 50 in proper order, thus forming a matrixarray of IR sensors 51 on the surface of the transparent plate 50. The array of IR sensors 51 defines a coordinate system, and each of the IR sensors 51 is located at particular coordinates. The material of the circuit layer is transparent, e.g., the circuit layer can be made of indium tin oxide (ITO).

Referring again to FIG. 4, the IR beams reflected by the scanning mirror 41, 42 enter the LGP 20 from different directions. Some of the IR beams reaching the first surface 24 are refracted and escape, while some of the IR beams are internally reflected and continue to be reflected multiple times between the first surface 24 and the second surface 25. Some of the IR beams reaching the second surface 25 are refracted and enter the transparent plate 50, then reach the IR sensors 51, while some of the IR beams are internally reflected multiple times between the first surface 24 and the second surface 25 and ultimately reach the IR sensors 51. All of the IR sensors 51 can receive IR beams, because the IR beams are internally reflected multiple times between the first surface 24 and the second surface 25.

When the LGP 20 is touched by a fingertip or stylus and the IR beams internally reflected in the LGP 20 reach the point of touch, the IR beams are not reflected by the first surface 24 because of the interruption of the finger or stylus touching the first surface 24. The IR beams at the point of touch are absorbed by the finger. As a result, the strength of the IR beams received by the one or more of the IR sensors 51 under the touch point is decreased. Thus, the position of the touch point can be determined according to the output of the one or more of the IR sensors 51.

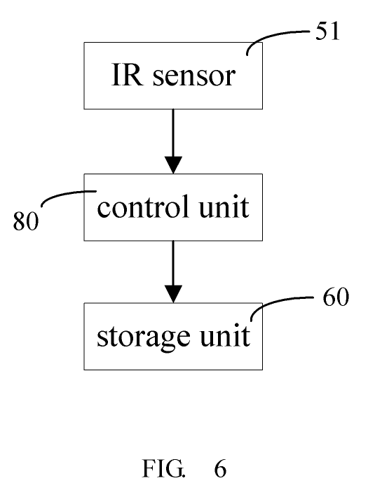

Referring to FIG. 6, the reflective display device 100 further includes a control unit 80 and a storage unit 60 storing a predetermined threshold of sensitivity of the IR sensors 51 in relation to the IR beams. Each of the IR sensor 51 detects whether the strength of received IR beams is below the predetermined threshold. When the reflective display device 100 is touched by a finger or a stylus, the strength of the IR beams received by the one or more of the IR sensors 51 under the touch point is decreased, and if the one or more of the IR sensors 51 under the touch point detects that the strength of received IR beams is below the predetermined threshold, the one or more of the IR sensors 51 output a signal associated with the touch to the control unit 80. The control unit 80 receives the signal and determines the position(s) of the one or more of the IR sensors 51, and may accordingly determine the position of the touched point according to the location of said IR sensor.

In another embodiment, the light sources 31, 32 and the scanning mirrors 41, 42 are arranged on the lateral sides of the LGP 20. The number of the light sources and scanning mirrors can be varied.

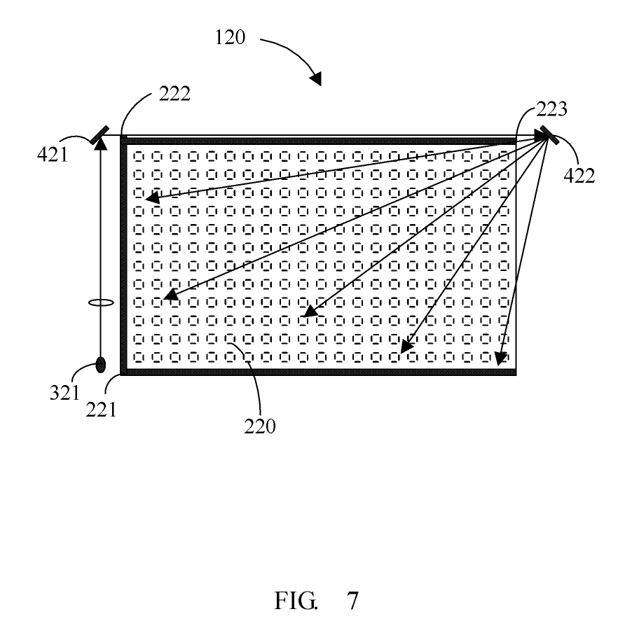

Referring to FIG. 7, a touch sensitive unit 120 according to a second embodiment is illustrated. The Touch sensitive unit 120 is similar to the touch sensitive unit 110 described above. An LGP 220 of the display device includes a first corner 221, a second corner 222 adjacent to the first corner 221 and a third corner 223 diagonally opposite the first corner 221. The difference between the touch sensitive units 120 and 110 is that an IR source 321 is arranged on the first corner 221, and a first scanning mirror 421 is arranged on the second corner 222, and a second scanning mirror 422 is arranged on the third corner 223. In the second embodiment, the first scanning mirror 421 and the second scanning mirror 422 are uniaxial MEMS scanning mirrors that have a two-dimensional scanning ability, and can reflect light beams. The rotational axis of the first scanning mirror 421 is orthogonal to the rotational axis of the second scanning mirror 422.

The IR beams emitting from the light source 321 travel to the first scanning mirror 421, and are reflected by the first scanning mirror 421. The reflected IR beams travel in different directions (in two dimensions) because of the tilting of the reflection plane of the first scanning mirror 421. The reflected IR beams are further reflected by the second scanning mirror 422 and travel in different directions (in three dimensions). Finally, the IR beams enter the LGP 220 through the incidence portion (not labeled) which is defined on the lateral surface of the LGP 220.

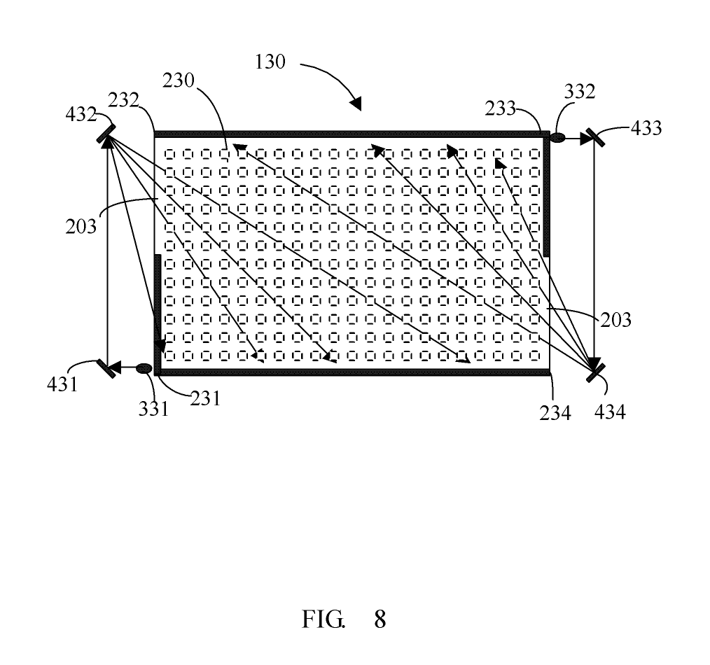

Referring to FIG. 8, a touch sensitive unit 130 of a display device (not shown) according to a third embodiment is illustrated. The touch sensitive unit 130 is similar to the touch sensitive unit 120 described above in the second embodiment. An LGP 230 of the display device includes a first corner 231, a second corner 232 adjacent to the first corner 231, a third corner 233 diagonally opposite the first corner 231, and a fourth corner diagonally opposite the second corner 232. The difference between the touch sensitive units 130 and 120 is that an IR source 331 and a first scanning mirror 431 are arranged on the first corner 231, and an IR source 332 and a first scanning mirror 433 are arranged on the first corner 233. A second scanning mirror 432 is arranged on the second corner 232 and a second scanning mirror 434 is arranged on the fourth corner 234.

In this third embodiment, the first scanning mirror 431, 433 and the second scanning mirror 432,434 are uniaxial MEMS scanning mirrors. The rotational axis of the first scanning mirror 431 is orthogonal to the rotational axis of the second scanning mirror 432, and the rotational axis of the first scanning mirror 433 is orthogonal to the rotational axis of the second scanning mirror 434.

The IR beams emitted from the light source 331 travel to the first scanning mirror 431, and are reflected by the first scanning mirror 431. The reflected IR beams travel in different directions (in two dimensions) because of the tilting of the reflection plane of the first scanning mirror 431. The reflected IR beams are further reflected by the second scanning mirror 432 and travel in different directions (in three dimensions). Finally, the IR beams enter the LGP 230 through the incidence portion 203 which is defined on the lateral surface of the LGP 230. Similarly, the IR beams emitted from the light source 332 are scanned and reflected twice, by the first scanning mirror 433 and by the second scanning mirror 434, and the reflected IR beams travel in different directions (in three dimensions) and then enter the LGP 230.

In other embodiments, the dispositions of the touch sensitive units 110, 120 and 130 may be not limited to the front plane of a reflective display device. In other embodiments, the touch sensitive units 110, 120 and 130 can be employed in a backlit LCD display or other type of display. In such cases, the touch sensitive units 110, 120 or 130 can be disposed on the front surface of the display, the IR beams reflected by the scanning mirrors may enter the LGP, and the position of any touched point can be determined as the location of each correctly-responding IR sensor which corresponds to positional coordinates.

The function(s) of any of the touch sensitive units 110, 120 and 130 or any of them can be utilized independently from the other two.

If any of the touch sensitive units 110, 120 and 130 is independently used as an IR touch input device, the IR touch input device will include the touch sensitive unit and a processing unit. The method of determining any touched point is similar to that described above.

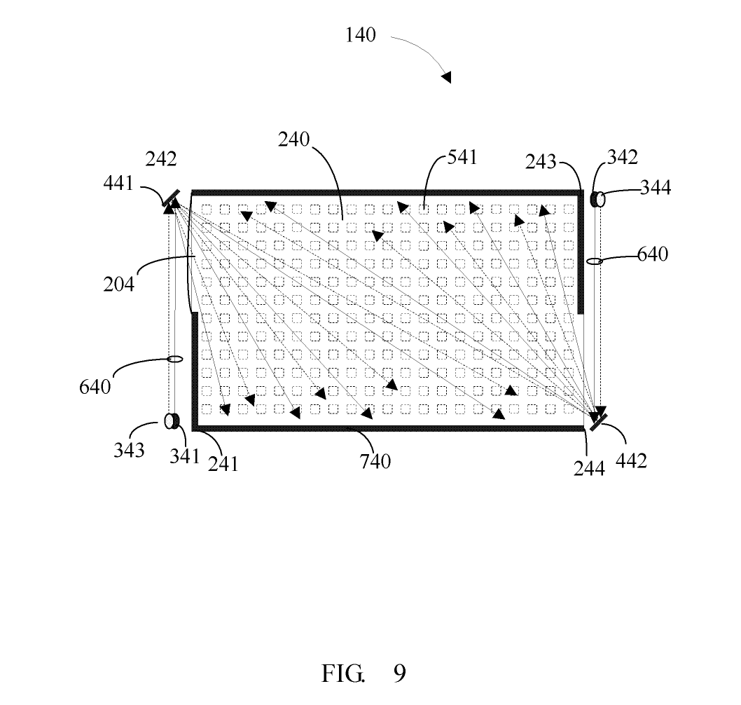

Referring to FIG. 9, a reflective display device (not labeled) according to a fourth embodiment is illustrated. The reflective display device is similar to the reflective display device 100 described above, the reflective display device includes a touch sensitive unit 140. An LGP 240 of the reflective display device includes a first corner 241, a second corner 242 adjacent to the first corner 241, a third corner 243 diagonally opposite the first corner 241, and a fourth corner diagonally opposite the second corner 242. The difference between the reflective display devices 140 and 100 is that a light source 341 and an IR source 343 are arranged on the first corner 241 of the LGP 240, and a light source 342 and an IR source 344 are arranged on the third corner 243 of the LGP 240. The light sources 341, 342 can be white LEDs or RGB mixed LEDs. A scanning mirror 441 is arranged on the second corner 242 and a scanning mirror 442 is arranged on the fourth corner 244. The scanning mirrors 441, 442 are biaxial MEMS scanning mirrors.

The light beams emitted from the light source 341 travel to the scanning mirror 441, and are reflected by the scanning mirror 441. The reflected light beams travel in different directions (in three dimensions) because of the tilting of the reflection plane of the scanning mirror 441. After being reflected by the scanning mirror 441, the reflected light beams then enter the LGP 240 through the incidence portion 204 defined on the lateral surface of the LGP 240. In a similar way, the light beams being emitted from the light source 342 are reflected by the scanning mirror 442, the reflected light beams entering the LGP 240 through the incidence portion 204.

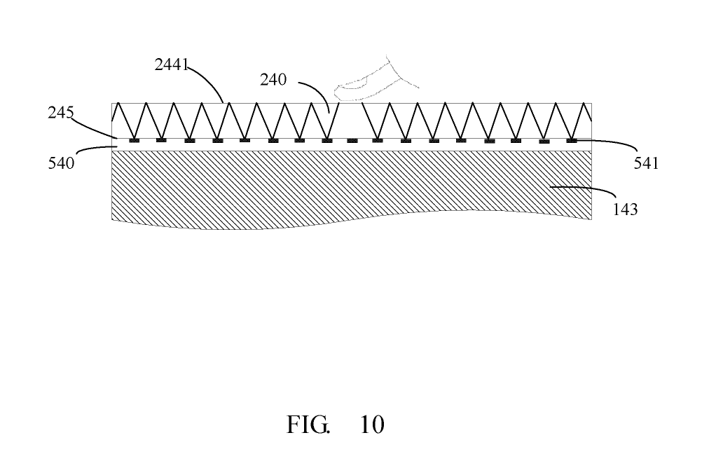

Referring to FIG. 10, the LGP 240 includes a first surface 24411 and an opposite, second surface 245. The reflective display device 140 further includes a diffuser plate 540 arranged between the second surface 245 and a display layer 143. The diffuser plate 540 is configured for scattering any light beams (including ambient incident light) which enter, and may create a backlit effect. Similar to the first embodiment, the diffuser plate 540 includes a plurality of IR sensors 541. In this embodiment, the IR sensors 541 are disposed on the surface of the transparent plate 540. The IR sensors 541 can be formed by film-printing process or by semiconductor processing technology.

The light beams reflected by the scanning mirror 441, 442 enter the LGP 240 in different directions. Some of the light beams reaching the first surface 2441 are refracted and escape, while some of the light beams are internally reflected multiple times between the first surface 2441 and the second surface 245. Some of the light beams reaching the second surface 245 are refracted and strike the diffuser plate 540, then reach the display layer 143, while some of the light beams are internally reflected multiple times between the first surface 2441 and the second surface 245 and ultimately reach the display layer 143. As a result, largely homogeneous light beams may be directed up to the display layer 143, which can contribute to an illuminated and comfortable display of content on the display layer 143. When the ambient light is weak or there is no ambient light, the light source 341, 342 can be turned on to provide illumination for the display layer 143.

As described above, the IR beams being emitted from the IR source 343 are reflected by the scanning mirror 441, the IR beams being emitted from the IR source 344 are reflected by the scanning mirror 442, the reflected light beams entering the LGP 240 through the incidence portion 204. Some of the IR beams reaching the first surface 2441 are refracted and escape, while some of the IR beams are internally reflected and continue to be reflected multiple times between the first surface 2441 and the second surface 245.

When the LGP 240 is touched, the strength of the IR beams received by the one or more of the IR sensors 541 under the touched point is decreased, thus the position of the touched point can be determined according to the output of the one or more of the IR sensors 541 under the touched point.

A condenser lens 640 may be arranged between the light source 341 and the scanning mirror 441, to focus the light beams being emitted from the light source 341. Similarly, a condenser lens 640 may be arranged between the light source 342 and the scanning mirror 442. In other embodiments, the light source can be a laser light source, and in that case, the condenser lens 640 can be omitted because the light from a laser light source is coherent and condensed in any event.

A reflection film 740 coating is present on each sidewall of the LGP 240 except for the incidence portion 204. The light beams and IR beams reaching the reflection film 740 will be reflected back, and not scattered or lost. The reflection film 740 can be a reflective metal coating arranged on the sidewall of the LGP 240.

In other embodiments, the light sources 341, 342, the IR sources 343, 344 and the scanning mirrors 441, 442 are arranged on the lateral sides of the LGP 240. The number of the light sources can be more than two, and one IR source is paired with one light source. The number of scanning mirrors is equal to the number of the light sources.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A display device comprising:
a display layer;
a light guide plate (LGP) arranged on the display layer, the LGP comprising a first surface facing away from the display layer, an opposite second surface, and a lateral surface between the first surface and second surface, the lateral surface comprising a light incident portion;
a transparent plate arranged between the second surface and the display layer,
an array of infrared (IR) sensors on a surface of the transparent plate;
a control unit;
an IR light source arranged on the lateral surface of the LGP, and
a scanning mirror arranged on the lateral surface of the LGP, the IR source being configured to emit IR light beams, the scanning mirror being configured to reflect and direct the IR light beams from the IR light source to enter the LGP through the light incident portion;
wherein each of the IR sensors is configured to sense the IR light beams and determine whether a strength of the sensed IR light beams is decreased to below a predetermined threshold value, caused by a touch by a user, on the transparent plate at a location of said IR sensor, and send a signal associated with the touch to the control unit, the control unit is configured to receive the signal and determine the touch point according to the location of said IR sensor.

2. The display device of claim 1, wherein the scanning mirror is a micro-electro-mechanical system (MEMS) scanning mirror.

3. The display device of claim 2, wherein the scanning mirror is a bi-axial MEMS scanning mirror.

4. The display device of claim 2, wherein the scanning mirror is two uniaxial MEMS scanning mirrors, and rotating axes of the two scanning mirrors are orthogonal to each other.

5. The display device of claim 1, wherein the lateral surface of the LGP comprises the light incident portion and a light reflecting portion, and a reflection film is applied on the light reflecting portion of the lateral surface.

6. The display device of claim 5, wherein the reflection film is a metal reflecting coating chosen from the group consisting of an aluminum coating, a gold coating and a silver coating.

7. A touch sensitive device comprising:
an LGP, the LGP comprising a first surface facing away from the display layer, an opposite second surface, and a lateral surface between the first surface and second surface, the lateral surface comprising a light incident portion;
a transparent plate arranged between the second surface and the display layer;
an array of infrared (IR) sensors arranged on a surface of the transparent plate;
a control unit;
an IR light source arranged on the lateral surface of the LGP, and a scanning mirror arranged on the lateral surface of the LGP, the IR light source being configured to emit IR light beams toward the scanning mirror, the scanning mirror being configured to reflect and direct the IR beams from the IR light source to enter the LGP through the light incident portion;
wherein each of the IR sensors is configured to sense the IR light beams and determine whether a strength of the sensed IR light beams is decreased to below a predetermined threshold value, caused by a touch by a user, on the transparent plate at a location of said IR sensor, and send a signal associated with the touch to the control unit, the control unit is configured to receive the signal and determine the touch point according to the location of said IR sensor.

8. The touch sensitive device of claim 7, wherein the scanning mirror is a MEMS scanning mirror.

9. The touch sensitive device of claim 8, wherein the scanning mirror is a bi-axial MEMS scanning mirror.

10. The touch sensitive device of claim 8, wherein the scanning mirror is two uniaxial MEMS scanning mirrors, and the rotating axis of the two scanning mirrors are orthogonal to each other.

11. The touch sensitive device of claim 7, wherein the lateral surface of the LGP comprises of the light incident portion and a light reflecting portion, and a reflection film is applied on the light reflecting portion of the lateral surface.

12. The touch sensitive device of claim 11, wherein the reflection film is a metal reflecting coating chosen from the group consisting of an aluminum coating, a gold coating and a silver coating.

13. A reflective display device comprising:
a display layer;
an LGP arranged on the display layer, the LGP comprising a first surface facing away from the display layer, an opposite, second surface, and a lateral surface between the first surface and second surface, the lateral surface comprising a light incident portion;
a diffuser plate arranged between the second surface and the display layer, an array of IR sensors on a surface of the diffuser plate;
a control unit;
an IR light source and a light source arranged on the lateral surface of the LGP, and a scanning mirror arranged on the lateral surface of the LGP, the light source configured to emit light beams toward the scanning mirror, the IR source configured to emit IR beams toward the scanning mirror, the scanning mirror configured to reflect and direct the light beams and IR beams to enter into the LGP through the light incident portion;
wherein each of the IR sensors is configured to sense the IR light beams and determine whether a strength of the sensed IR light beams is decreased to below a predetermined threshold value, caused by a touch by a user, on the transparent plate at a location of said IR sensor, and send a signal associated with the touch to the control unit, the control unit is configured to receive the signal and determine the touch point according to the location of said IR sensor.

14. The reflective display device of claim 13, wherein the scanning mirror is a MEMS scanning mirror.

15. The reflective display device of claim 14, wherein the scanning mirror is a bi-axial MEMS scanning mirror.

16. The reflective display device of claim 14, wherein the scanning mirror is two uniaxial MEMS scanning mirrors, the rotating axis of the two scanning mirrors are orthogonal to each other.

17. The reflective display device of claim 13, wherein the lateral surface of the LGP comprises the light incident portion and a light reflecting portion, and a reflection film is applied over the light reflecting portion of the lateral surface.

18. The reflective display device of claim 17, wherein the reflection film is a metal reflecting coating chosen from the group consisting of an aluminum coating, a gold coating and a silver coating.

19. The reflective display device of claim 13, wherein the light source is an LED or a laser light source.

20. The reflective display device of claim 13, wherein a converging lens is arranged between the light source and the scanning mirror.
